(19) United States
(12) Patent Application Publication
(10) Pub. No.: US 2003/0111904 A1
(43) Pub. Date: Jun. 19, 2003

(54) Endless track drive sprocket system

(76) Inventor: Dale D. Cormican, Mentor, MN (US)

Correspondence Address: Michael S. Neustel, Suite No.4, 2534 South University Drive, Fargo, ND, 58103, US

(21) Appl. No.: 10/016,033

(22) Filed: Dec. 12, 2001

(51) Int. Cl. B62D 55/12

(52) U.S. Cl. 305/199

(57) ABSTRACT

An endless track drive sprocket system for reducing slippage between a drive sprocket and an endless track. The endless track drive sprocket system includes a main body having a generally circular structure, a plurality of first flat portions within an outer perimeter of the main body, a plurality of second flat portions within the outer perimeter of the main body positioned between the first flat portions at an angle, and a first engaging member and a second engaging member extending outwardly from the main body adjacent to the second flat portions. The intersection of the first flat portions and the second flat portions creates a pressure ridge for reducing the chance of the engaging members slipping upon the lugs of the endless track.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to endless track drive sprockets and more specifically it relates to an endless track drive sprocket system for reducing slippage between a drive sprocket and an endless track.

2. Description of the Prior Art

Endless tracks for snowmobiles and other vehicles have been in use for years. An endless track typically includes a plurality of lugs within the interior thereof. The snowmobile or similar vehicle utilizes one or more drive sprockets for engaging the plurality of lugs for rotating the endless track within the vehicle. A conventional drive sprocket has a circular circumference with a plurality of engaging member extending from the side portions thereof.

The main problem with conventional drive sprockets is that they sometime easily slip over a lug when a significant force is applied to the lug. A further problem with conventional drive sprockets is that they increase the wear upon the lugs of the endless track thereby reducing the useful life of the endless track.

While these devices may be suitable for the particular purpose to which they address, they are not as suitable for reducing slippage between a drive sprocket and an endless track. Conventional drive sprockets are susceptible to slipping upon the plurality of lugs within an endless track.

In these respects, the endless track drive sprocket system according to the present invention substantially departs from the conventional concepts and designs of the prior art, and in so doing provides an apparatus primarily developed for the purpose of reducing slippage between a drive sprocket and an endless track.

### SUMMARY OF THE INVENTION

In view of the foregoing disadvantages inherent in the known types of drive sprockets now present in the prior art, the present invention provides a new endless track drive sprocket system construction wherein the same can be utilized for reducing slippage between a drive sprocket and an endless track.

The general purpose of the present invention, which will be described subsequently in greater detail, is to provide a new endless track drive sprocket system that has many of the advantages of the drive sprockets mentioned heretofore and many novel features that result in a new endless track drive sprocket system which is not anticipated, rendered obvious, suggested, or even implied by any of the prior art drive sprockets, either alone or in any combination thereof.

To attain this, the present invention generally comprises a main body having a generally circular structure, a plurality of first flat portions within an outer perimeter of the main body, a plurality of second flat portions within the outer perimeter of the main body positioned between the first flat portions at an angle, and a first engaging member and a second engaging member extending outwardly from the main body adjacent to the second flat portions. The intersection of the first flat portions and the second flat portions creates a pressure ridge for reducing the chance of the engaging members slipping upon the lugs of the endless track.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an endless track drive sprocket system that will overcome the shortcomings of the prior art devices.

A second object is to provide an endless track drive sprocket system for reducing slippage between a drive sprocket and an endless track.

Another object is to provide an endless track drive sprocket system that reduces slippage between a drive sprocket and the plurality of lugs of an endless track.

An additional object is to provide an endless track drive sprocket system that reduces wear upon an endless track.

A further object is to provide an endless track drive sprocket system that extends the useful life of an endless track.

Another object is to provide an endless track drive sprocket system that increases the overall performance of the drive train of a snowmobile or similar vehicle.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a side view of the present invention.

FIG. 3 is a side view of the present invention positioned within an endless track.

FIG. 4 is a top view of the present invention.

FIG. 5 is an upper perspective view of the present invention positioned upon a drive shaft.

FIG. 6 is a side view of the present invention positioned within an endless track.

### DESCRIPTION OF THE PREFERRED EMBODIMENT

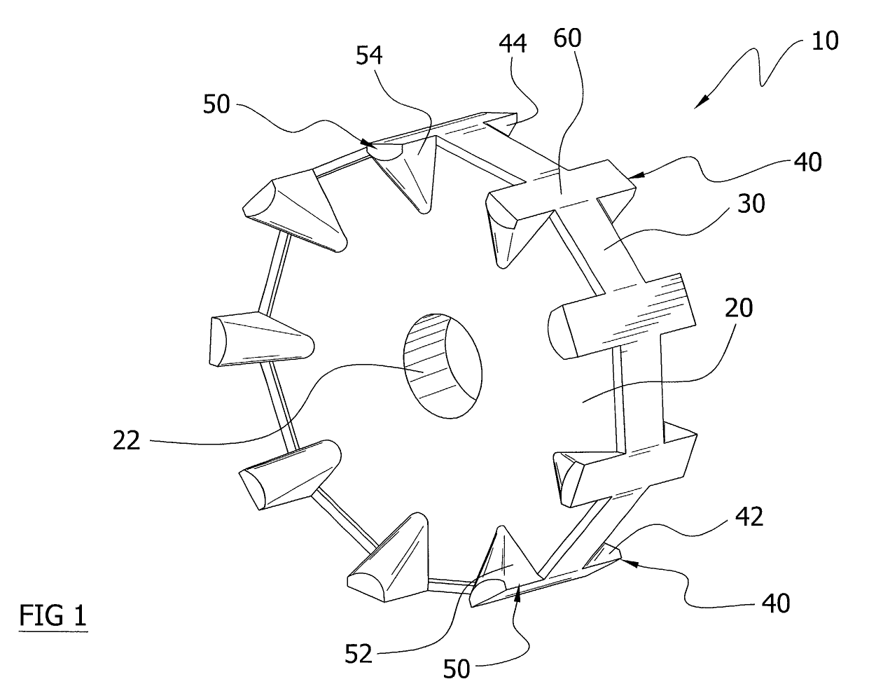

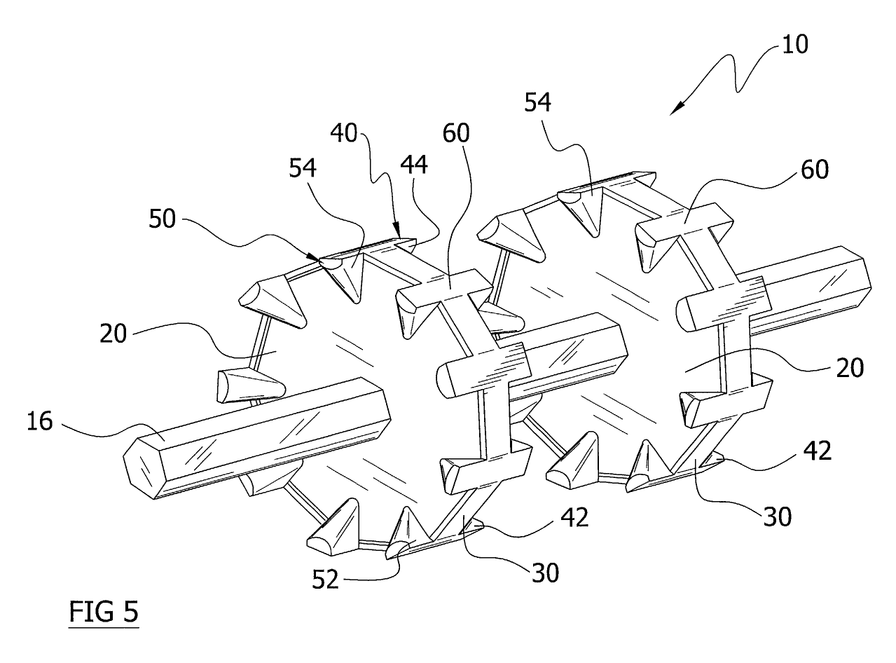

Turning now descriptively to the drawings, in which similar reference characters denote similar elements throughout the several views, FIGS. 1 through 6 illustrate an endless track drive sprocket system 10, which comprises a main body 20 having a generally circular structure, a plurality of first flat portions 30 within an outer perimeter of the main body 20, a plurality of second flat portions 60 within the outer perimeter of the main body 20 positioned between the first flat portions 30 at an angle, and a first engaging member and a second engaging member extending outwardly from the main body 20 adjacent to the second flat portions 60. The intersection of the first flat portions 30 and the second flat portions 60 creates a pressure ridge for reducing the chance of the engaging members slipping upon the lugs 14 of the endless track 12.

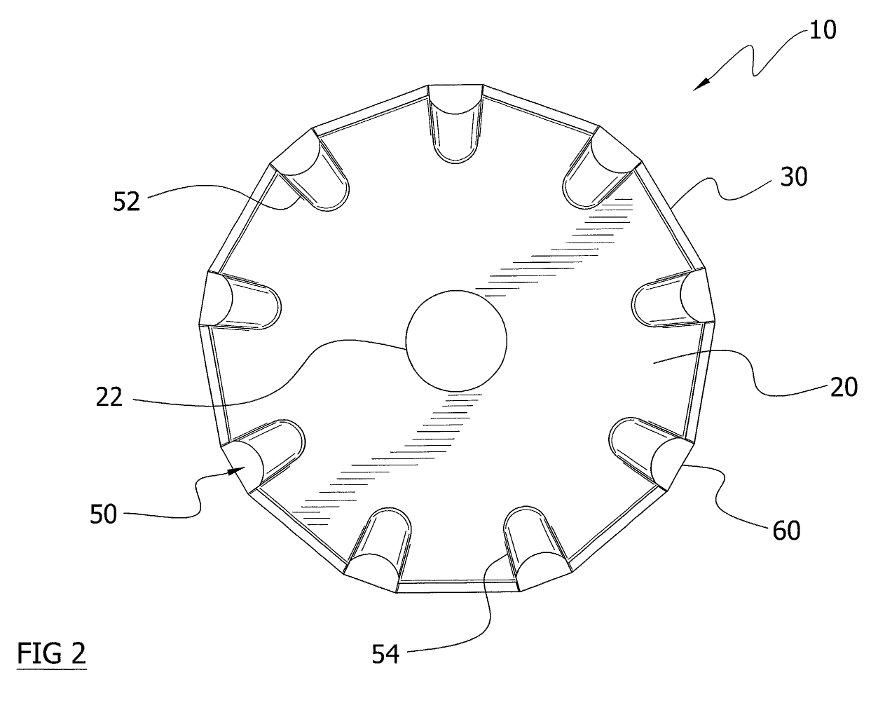

As shown in FIGS. 1 through 5 of the drawings, the main body 20 is comprised of a generally narrow structure having a generally circular shape. The main body 20 has an outer perimeter that has a plurality of flat and straight portions at angles with respect to one another. The main body 20 may be comprised of various types of materials such as but not limited to plastic and composite materials. The main body 20 has a first side and a second side. As shown in FIGS. 1 and 2 of the drawings, the main body 20 includes a center aperture 22 for fitting about the drive shaft 16 of the vehicle such as a snowmobile. The center aperture 22 may be comprised of various shapes and sizes to non-movably engage the drive shaft 16 as is well known in the art of drive sprockets.

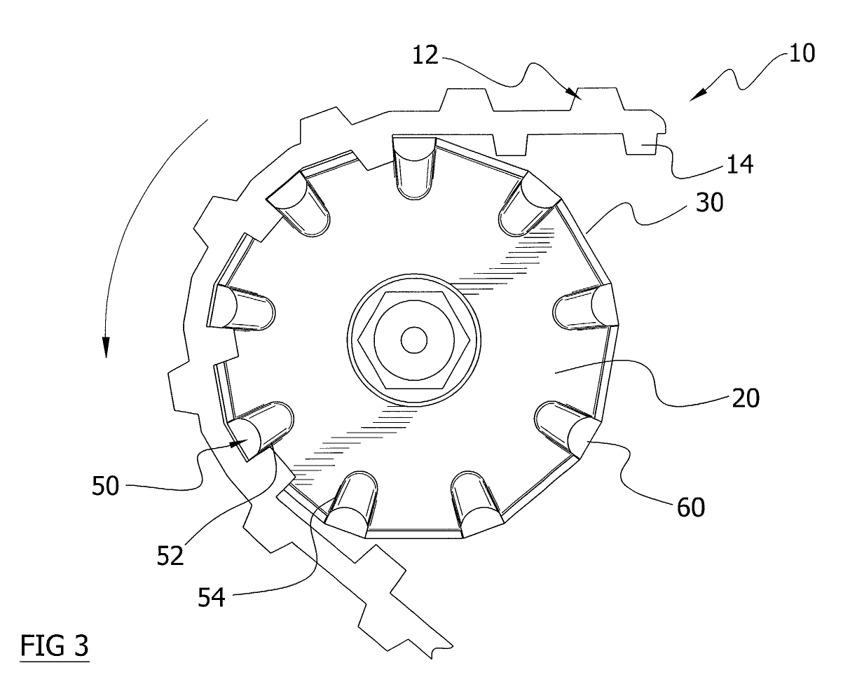

As shown in FIGS. 1 through 5 of the drawings, a plurality of first flat portions 30 and a plurality of second flat portions 60 extend into the outer perimeter of the main body 20 in a staggered manner. The flat portions 30, 60 are comprised of a straight and flat structure as best shown in FIGS. 2 and 3 of the drawings.

Each of the flat portions 30, 60 are tangential with respect to the outer perimeter as shown in FIG. 2 of the drawings. The intersection of the first flat portions 30 with the second flat portions 60 creates a pressure ridge wherein a significant portion of the tension force of the endless track 12 is placed at the pressure ridge intersection. The angle between the first flat portions and the second flat portions is preferably less than 170 degrees and greater than 150 degrees though various other ranges may be used as best shown in FIG. 2 of the drawings. As further shown in FIG. 2 of the drawings, the first flat portions 30 are significantly longer than the second flat portions 60.

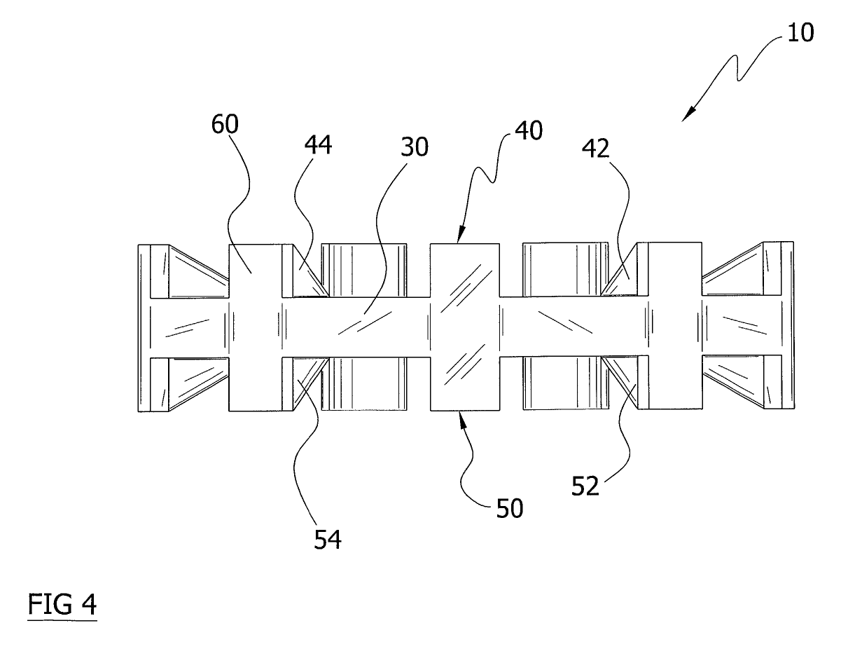

A plurality of first engaging members 40 extend from the first side of the main body 20 adjacent to each of the second flat portions 60. The upper surface of the first engaging members 40 preferably corresponds to the second flat portions 60 as best shown in FIG. 4 of the drawings. Each of the first engaging members 40 includes a first engaging side 42 which is the portion of the first engaging member that directly engages the lugs 14 of the endless track 12 during operation thereof and is adjacent to the pressure ridge of the outer perimeter. A first opposing side 44 is positioned opposite of the first engaging side 42, wherein the first opposing side 44 typically does not engage the endless track 12.

A plurality of second engaging members 50 extend from the second side of the main body 20 adjacent to each of the second flat portions 60 opposite of the first engaging members 40. The second engaging members 50 are formed for engaging the lugs 14 of the endless track 12 opposite of the lugs 14 engaged by the first engaging members 40.

The upper surface of the second engaging members 50 preferably corresponds to the second flat portions 60 and the upper surface of the first engaging members 40 as best shown in FIG. 4 of the drawings. Each of the second engaging members 50 includes a second engaging side 52 which is the portion of the second engaging member that directly engages the lugs 14 of the endless track 12 during operation thereof and is adjacent to the pressure ridge of the outer perimeter. A second opposing side 54 is positioned opposite of the second engaging side 52, wherein the second opposing side 54 typically does not engage the endless track 12.

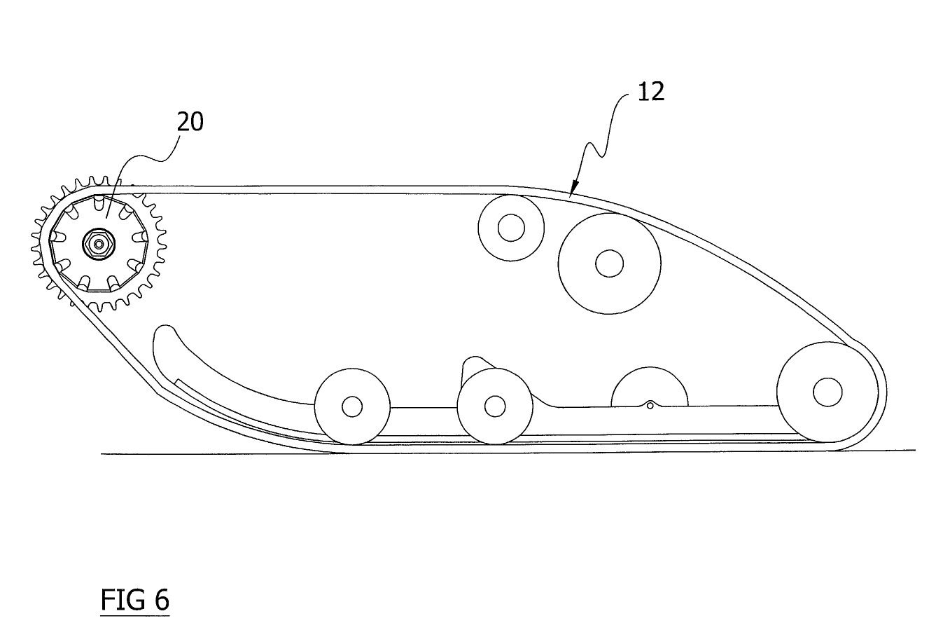

In use, the interior surface of the endless track 12 is positioned adjacent to the outer perimeter of the main body 20 as shown in FIGS. 3 and 6 of the drawings. More particularly, the raised pressure ridges created at the intersections of the first flat portions 30 and the second flat portions 60 receive a significant portion of the tension forces applied by the endless track 12 thereby reducing the likelihood of slippage about the corresponding lugs 14 of the endless track 12. When the drive shaft 16 is rotated, the engaging sides 42, 52 of the engaging members 40, 50 engage the respective lugs 14 of the endless track 12. The engaging sides 42, 52 engage the lugs 14 at the highest pressure point upon the endless track 12 with respect to the outer perimeter thereby reducing the likelihood of the endless track 12 expanding away from the engaging members 40, 50 which typically results in slippage upon the lugs 14. This process continues until the user terminates operation of the vehicle.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Endless Track Drive Sprocket System

□ENVIRONMENTAL ELEMENTS
□
□
□
□
□
□
□
□
□
□ 10. Endless Track Drive Sprocket System
□ 11.
□ 12. Endless Track
□ 13.
□ 14. Lugs
□ 15.
□ 16. Drive Shaft
□ 17.
□ 18.
□ 19.
□ 20. Main Body
□ 21.
□ 22. Center Aperture
□ 23.
□ 24.
□ 25.
□ 26.
□ 27.
□ 28.
□ 29.
□ 30. First Flat Portion
□ 31.
□ 32.
□ 33.
□ 34.
□ 35.
□ 36.
□ 37.
□ 38.
□ 39.
□ 40. First Engaging Member
□ 41.
□ 42. First Engaging Side
□ 43.
□ 44. First Opposing Side
□ 45.
□ 46.
□ 47.
□ 48.
□ 49.
□ 50. Second Engaging Member
□ 51.
□ 52. Second Engaging Side
□ 53.
□ 54. Second Opposing Side
□ 55.
□ 56.
□ 57.
□ 58.
□ 59.
□ 60. Second Flat Portion
□ 61.
□ 62.
□ 63.
□ 64.
□ 65.
□ 66.
□ 67.
□ 68.
□ 69.
□ 70.
□ 71.
□ 72.
□ 73.
□ 74.
□ 75.
□ 76.
□ 77.
□ 78.
□ 79.

1. An endless track drive sprocket system for driving an endless track having a plurality of lugs, comprising:
a main body having a first side, a second side, a center aperture and an outer perimeter, said outer perimeter including a plurality of first flat portions and a plurality of second flat portions staggered with respect to one another;
a plurality of first engaging members extending from said first side adjacent to said second flat portions; and
a plurality of second engaging members extending from said second side adjacent to said second flat portions opposite of said first engaging members.

2. The endless track drive sprocket system of claim 1, wherein said first flat portions and said second flat portions are each comprised of a straight structure.

3. The endless track drive sprocket system of claim 1, wherein said first flat portions and said second flat portions form an obtuse angle between each intersection thereof.

4. The endless track drive sprocket system of claim 3, wherein said obtuse angle is greater than 150 degrees and less than 170 degrees.

5. The endless track drive sprocket system of claim 1, wherein said first flat portions and said second flat portions form a pressure ridge intersection at each intersection thereof.

6. The endless track drive sprocket system of claim 5, wherein a first engaging side of said first engaging member is positioned adjacent said pressure ridge intersection, and wherein a second engaging side of said second engaging member is positioned adjacent said pressure ridge intersection.

7. The endless track drive sprocket system of claim 6, wherein said engaging members each include an upper surface that extend from said second flat portions.

8. The endless track drive sprocket system of claim 1, wherein said engaging members each include an upper surface that extend from said second flat portions.

9. The endless track drive sprocket system of claim 1, wherein said main body is comprised of a plastic material.

10. The endless track drive sprocket system of claim 1, wherein said first flat portions are each at least twice as long as said second flat portions.

11. An endless track drive sprocket system for driving an endless track having a plurality of lugs, comprising:
a main body having a first side, a second side, a center aperture and an outer perimeter, said outer perimeter including a plurality of first flat portions and a plurality of second flat portions staggered with respect to one another; and
a plurality of engaging members extending from said main body adjacent to said second flat portions.

12. The endless track drive sprocket system of claim 11, wherein said first flat portions and said second flat portions are each comprised of a straight structure.

13. The endless track drive sprocket system of claim 11, wherein said first flat portions and said second flat portions form an obtuse angle between each intersection thereof.

14. The endless track drive sprocket system of claim 13, wherein said obtuse angle is greater than 150 degrees and less than 170 degrees.

15. The endless track drive sprocket system of claim 11, wherein said first flat portions and said second flat portions form a pressure ridge intersection at each intersection thereof.

16. The endless track drive sprocket system of claim 15, wherein an engaging side of said engaging members is positioned adjacent said pressure ridge intersection.

17. The endless track drive sprocket system of claim 16, wherein said engaging members each include an upper surface that extend from said second flat portions.

18. The endless track drive sprocket system of claim 11, wherein said engaging members each include an upper surface that extend from said second flat portions.

19. The endless track drive sprocket system of claim 11, wherein said main body is comprised of a plastic material.

20. The endless track drive sprocket system of claim 11, wherein said first flat portions are each at least twice as long as said second flat portions.
